(19) United States
(12) Patent Application Publication
(10) Pub. No.: US 2005/0178710 A1
(43) Pub. Date: Aug. 18, 2005

(54) Substance activating method and device therefor

(75) Inventor: Masayoshi Kitada, Wako-shi (JP)

Correspondence Address: MERCHANT & GOULD PC, P.O. BOX 2903, MINNEAPOLIS, MN, 55402-0903, US

(73) Assignee: Honda Giken Kogyo Kabushiki Kaisha, Tokyo (JP)

(21) Appl. No.: 10/503,202

(22) PCT Filed: Jan. 23, 2003
(86) PCT No.: PCT/JP03/00592

(30) Foreign Application Priority Data
Jan. 30, 2002 (JP) 2002-22050

(51) Int. Cl. B03C 1/02; C02F 1/48; B01D 35/06

(52) U.S. Cl. 210/222

(57) ABSTRACT

A process of activating a substance comprises a process that a substance to be treated is treated with magnetism in which an energy power changes repeatedly to allow polarized molecules in the substance to follow up an external magnetism. The substance can be suitably activated by the process of activating a substance.

### TECHNICAL FIELD

The present invention relates to a process of activating substance and an apparatus for activating substance for activating a predetermined substance by utilizing magnetism and/or an active structure. More specifically, the present invention relates to the magnetism in which an energy power changes repeatedly, and the active structure which activates a substance to be treated in which an energy focused placed among particles comprising a specific element is provided, and a substance to be treated, particularly a substance having a hydrogen such as water or a hydrocarbon, is passed through or stayed in such an energy focused place, to thereby activate the substance, and an apparatus and process for activating a substance utilizing the same.

### BACKGROUND ART

In recent years, from the viewpoints of global warming caused by carbon dioxide or drying up natural resources such as petroleum, attention has been paid to hydrogen as an alternative fuel.

These days, as a method of manufacturing the hydrogen, 90 percent of industrial hydrogen are manufactured from petroleum or natural gas as a steam-reforming method or a partial oxidizing method.

As other methods except for the above method, COG method or a producer gas-method in which coax is used as a crude material a method of recovering hydrogen of byproduct from a salt-electrolytic tank, and water-electrolysis had been performed as a conventional method.

Recently, the research has been made in order to provide a method of manufacturing hydrogen by utilizing a thermochemical reaction and a solar power.

As alternative method for generating hydrogen except for the above-mentioned method, thermal decomposition of water can be exemplified to generate hydrogen. It is, however, required, for thermally decomposing water to generate hydrogen, to carry out the thermal decomposition at a temperature as high as at least 1500° C. as a reaction temperature. Furthermore, in order to enhance efficiency of thermal decomposing water to generate hydrogen, it is required to carry out the thermal decomposition at a high temperature as high as approximately 4300° C., which requires much more energy and making it impossible to put the thermal decomposition of water into practical use unless heat source is less expensive.

Also, as a method for generating hydrogen, an alkali metal and or alkaline earth metal such as sodium, aluminum, and magnesium is added to water to bring about a chemical reaction can be considered, but these materials are expensive, and a reaction take place rapidly, making it difficult to put the chemical reaction into an industrial reaction.

Furthermore, as a method for generating hydrogen, electrolysis of the hydrocarbon such as methanol can be considered in stead of electrolysis of water. In a hydrocarbon, a bonding energy between hydrogen and carbon in a molecule is relatively low and, thus, the potential difference required for electrolyzing the hydrocarbon may be considered to be relatively low, but the electrolysis of the hydrocarbon involves the formation of by-products such as CO and CO₂ during the course of the reaction and, therefore, the method should be required for liberating and removing such by-products.

We have been made a serious study and research in an active structure which can liberate hydrogen from hydrogen bond in water and hydrocarbons to generate hydrogen without applying any external energy. As a result, we filed the application JP application No. 2001-021734.

However, there has been a requirement for further improving a property of the active structure and, thus, we have been made a serious study and research in the method as described above for treating several kinds of substance to be treated. As a result, it has been discovered the present invention.

The present invention was made to solve the above mentioned drawbacks. An object of the present invention is, therefore, to provide a process of activating substance and apparatus for activating substance which can suitably activating substances to be treated.

### SUMMARY OF THE INVENTION

In order to solve the above mentioned drawbacks, a process of activating a substance as one example of the embodiment of the present invention comprise a process (A) that a substance to be treated is treated with magnetism in which an energy power changes repeatedly.

According to a process of activating a substance as one example of the embodiment of the present invention, a substance to be treated is treated with magnetism in which an energy power changes repeatedly to allow polarized molecules in the substance to follow up an external magnetism.

The process of activating a substance according to the present invention comprises the above mentioned process (A), and a process (B) for activating the substance to be treated before and/or after the process (A).

According to the process of activating a substance having such process (A) and (B), the substance to be treated can be more suitably activated.

As a method in the process (A) of applying the magnetism to the substance to be treated, it is preferable for applying a microwave generated in a high voltage-pulse oscillator to the substance.

According to the above mentioned process (A), the substance to be treated can be activated by the microwave generated in a power source of a high voltage and a small amount of power consumption.

As a method in the process (A) of applying the magnetism to the substance to be treated, it is preferably a method that the substance is passed through a cylindrical case wherein a plurality of permanent magnet is provided in such a manner that a magnetic direction is changed at every one permanent magnet.

According to the above mentioned process (A), a vibration magnetic filed can be imparted to the substance. Thus, the substance can be easily activated.

Furthermore, as a method in the process (A) of applying the magnetism to the substance to be treated, it is also preferably a method that the substance is passed through a cylindrical case having a coil, which is wound around the cylindrical case, while alternating current flows in the coil.

According to the above mentioned process (A), a vibration magnetic filed can be imparted to the substance. Thus, the substance can be easily activated.

The above mentioned process (B) is preferably an activating treatment process of passing the substance through the active structure comprising particles consisting essentially of a single element selected from the group consisting of silicon, titanium, nickel, and samarium, or of a carbon fluoride placed in the position where a wave motion energy inherent to each of the elements or the carbon fluoride is amplified.

By such a configuration, the substance can be more preferably activated.

The particles are arranged preferably at the apices of a regular tetrahedron, or the apices of a regular triangle.

When the particles are arranged at the apices of a regular tetrahedron, or the apices of a regular triangle, a high energy (or an interaction thereof among the particles is generated, i.e., an energy focused place is generated, and a substance can be activated by passing the substance through the energy focused place, or by staying the substance in the energy focused place.

An apparatus for activating a substance as the other example of the embodiment of the present invention comprises an apparatus that the substance to be treated is activated with magnetism in which an energy power changes repeatedly.

By such a configuration, polarized molecules in the substance can be activated by following up an external magnetism.

The apparatus for activating a substance of the other example of the embodiment of the present invention can be provided preferably on an upstream and/or a downstream of the former apparatus for activating a substance.

By such a configuration, the substance can be suitably activated.

The apparatus for activating the substance of the other example of the embodiment of the present invention is preferably an apparatus in which magnetism generated by means of a high voltage pulse oscillator is applied to the substance.

By such a configuration, the substance can be activated by a microwave generated by means of a power supply which is a high voltage and a small amount of electric power consumption.

The apparatus for activating the substance can be comprised of an apparatus in which the substance is passed through a cylindrical case wherein a plurality of permanent magnet is provided in such a manner that a magnetic direction is changed at every one permanent magnet.

By such a configuration, the magnetism can be imparted to the substance by only passing the substance through the cylindrical case. Thus, the substance can be easily activated.

Furthermore, the apparatus for activating the substance can be comprised of a magnetic field generator using permanent magnets wherein an internal cylindrical case having a coil, which is wound around the internal cylindrical case to flow current therein, is provided in an external cylindrical case.

By such a configuration, the magnetism can be imparted to the substance by only passing the substance through the cylindrical case. Thus, the substance can be suitably activated.

The apparatus for activating the substance of the other example of the embodiment of the present invention is preferably an apparatus including an active structure comprising particles consisting essentially of a single element selected from the group consisting of silicon, titanium, nickel and samarium, or of a carbon fluoride placed in the position where a wave motion energy inherent to each of the elements or the carbon fluoride is amplified.

By such a configuration, the substance can be suitably activated.

The particles are arranged preferably at the apices of a regular tetrahedron, or the apices of a regular triangle.

When the particles are arranged at the apices of a regular tetrahedron, or the apices of a regular triangle, a high energy (or an interaction thereof among the particles is generated, i.e., an energy focused place is generated, and a substance can be activated by passing the substance through the energy focused place, or by staying the substance in the energy focused place.

The term “activation” intended herein not only encompasses that an energy is imparted to molecular and atoms so as to actively act due to a high energy condition, but also encompasses an exchange reaction, namely, a decomposition reaction between moleculars or between atoms.

### BRIEF DESCRIPTION OF THE DRAWINGS

FIG. 1A is a drawing showing the first embodiment of a power supply circuit of a high voltage pulse oscillator utilizing in the apparatus for activating the substance according to the present invention, FIG. 1B is a drawing showing a characteristic of a pulse generating oscillating from the power supply circuit shown in FIG. 1A, and FIG. 1C totally shows a structure of the apparatus for activating a substance of one example of preferred embodiments.

FIG. 2 is a schematic drawing showing an internal structure of the apparatus for activating the substance according to the second embodiment.

FIG. 3 is a schematic drawing showing an internal structure of the apparatus for activating the substance according to the third embodiment.

FIG. 4A is a longitudinal cross sectional view of the apparatus for activating the substance according to the fourth embodiment, and FIG. 4B is a process flow chart showing a process that hydrogen is generated by utilizing the apparatus for activating the substance according to the fourth embodiment.

FIG. 5 is a process flow chart showing a process that hydrogen is generated by utilizing the apparatus for activating the substance according to the fifth embodiment.

### BEST MODES FOR CARRYING OUT THE INVENTION

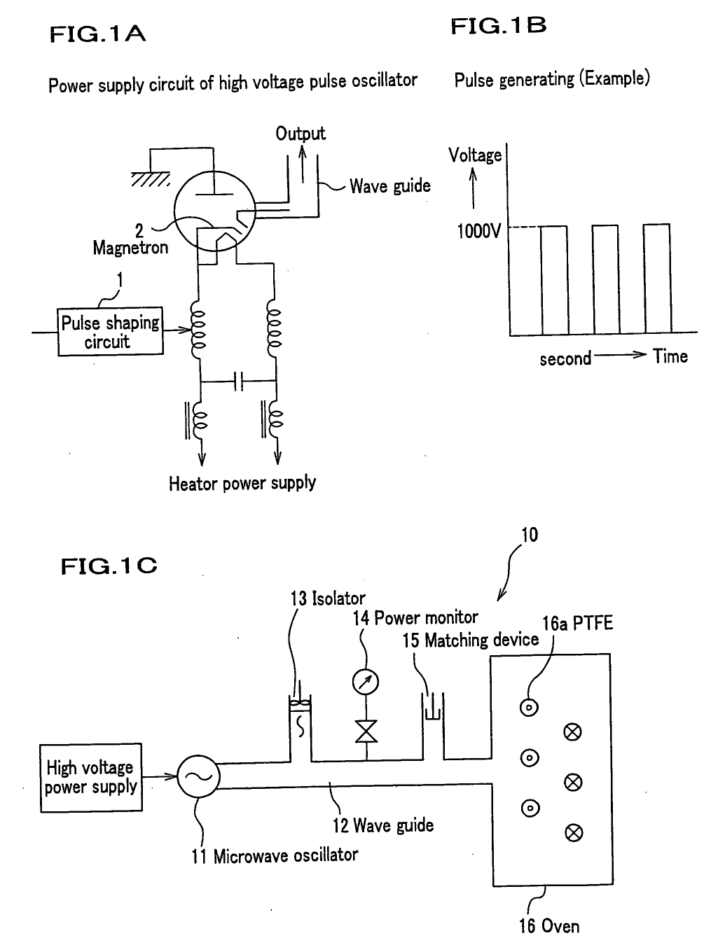

The present invention will now be specifically described by referring to FIG. 1 to FIG. 5. First, an apparatus for activating a substance of the first embodiment according to the present invention will now be described by referring to FIG. 1.

The apparatus for activating a substance is an apparatus to specify the method for activating a substance of the present invention.

FIG. 1A is a drawing showing the first embodiment of a power supply circuit of a high voltage pulse oscillator utilizing in the apparatus for activating the substance according to the present invention, FIG. 1B is a drawing showing a characteristic of a pulse generating oscillating from the power supply circuit shown in FIG. 1A, and FIG. 1C totally shows a structure of the apparatus for activating a substance of one example of preferred embodiments.

As shown in FIG. 1A, the power supply circuit of high voltage pulse oscillator utilizing in the apparatus for activating the substance of the first embodiment is an oscillating circuit utilizing a magnetron, which is suitable for oscillating a large power of microwave.

In the oscillating circuit, when a pulse wave from a pulse shaping circuit 1 is transmitted to a cathode 2 of a magnetron, a cathode potential becomes, for example, a few thousands voltages of a negative potential. As a result, the magnetron is oscillated. To the contrary, when the pulse wave is not transmitted to the cathode 2 of the magnetron, the magnetron is not oscillated since the cathode potential does not become a negative potential.

Accordingly, a wave shape of oscillation is configured as a rectangular shaped-pulse voltage output as shown in FIG. 1B. Magnetron has a high-energy efficiency so that it is suitable for a large output-oscillation. In the meantime, however, a frequency of magnetron can be easily changed depending upon a temperature variation or the like. For this reason, there is a case that a power Klystron is utilized in such as a Doppler radar requiring an accurate and stable frequency.

Since a microwave oscillated from magnetron has a high frequency (for example, 2.45 GHz, the microwave is transmitted via a wave-guide.

Furthermore, when an oscillator having a low frequency (for example 400 Hz) is utilized, the microwave can be transmitted via a wire cable instead of the wave-guide.

Next, a whole structure of the apparatus for activating a substance of the first embodiment will now be described by referring to FIG. 1C. Descriptions will be made for the case that water is used as the substance to be treated.

As shown in FIG. 1C, the apparatus 10 for activating a substance of the first embodiment is essentially consisted of a microwave oscillator 11, a wave guide 12, an isolator 13, a power monitor 14, a matching device 15, and a pipe 16a.

Herein, the microwave oscillator 11 is a high voltage pulse oscillator. The wave guide 12 transmits a microwave, which is oscillated from the micro oscillator 11, to the oven 16 of a rectangular shaped box. The isolator 13 attenuates a reflected power reflected off the oven 16 to protect the microwave oscillator 11. The power monitor 14 displays an incident power to the oven 16 and a reflected power reflected off 1 the oven 16. The matching device 15 adjusts the reflected power reflected off the oven 16 to a minimum by matching the reflected power with a circuit in the wave guide 12. The pipe 16a is made of a material (for example tetrafluoroethylene), which can penetrate into the microwave. Furthermore, the pipe 16a is provided on the oven 16.

Operation of the above mentioned apparatus for activating a substance of the first embodiment will now be described below.
(1) First, water is passed through the pipe 16a by means of pump (not shown).
(2) The microwave oscillator 11 is turned on to oscillate the microwave. Herein, a frequency is 2.45 GHz, while an impressed voltage is 1000V.
(3) The reflected power reflected off the oven 16 is adjusted to a minimum by adjusting the matching device 15 by confirming the power monitor 14.
(4) Water in outlet of the pipe 16 is heated until a temperature of water becomes a predetermined value (for example 80° C.) by adjusting an output of microwave or a flow rate of water so as to activate water as the substance to be treated.
(5) Microwave, which could not be absorbed into water in the oven 16, is transmitted to outside of the oven 16. Then, the microwave is converted into a heat by means of the isolator 13 so as to be emitted to outside of the system.

According to the apparatus for activating a substance of the first embodiment comprising the above mentioned structure and operation, the method of activating water is a method that the microwave generated by means of the microwave oscillator 11 is imparted to water as the substance.

Such a configuration can bring about the following effects.
(1) Since molecular of water are polarized, when an external microwave is imparted to water, molecular of water are violently vibrated and rotated due to the fact that molecular of water tend to be oriented toward a direction of an external electric filed. Thus, a frequency of microwave becomes higher not enough to follow up the external electric filed. Consequently, a frictional heat of intermolecular is increased so that water is heated and activated.
(2) Since microwave has a pulse characteristic as shown in FIG. 1B, even if a high voltage (1000V) is applied to the apparatus, the substance can be activated by a power supply having a small amount of power consumption. In the first embodiment, water as liquid substance is activated. However, gas (for example, oxygen) can also be activated when a dielectric ceramic is utilized as pipe instead of the pipe 16a made of a tetrafluoroethylene (PTFE).

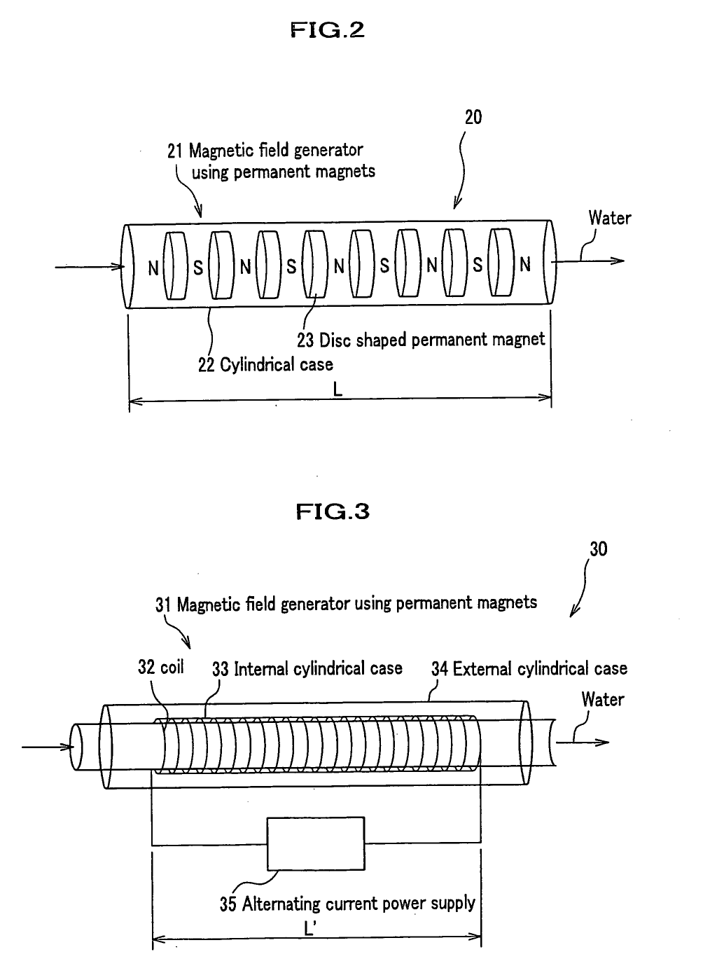

Next, an apparatus for activating a substance of the second embodiment will now be described by referring to FIG. 2. FIG. 2 is a schematic drawing showing internal structure of the apparatus for activating a substance of the second embodiment. As shown in FIG. 2, the apparatus 20 for activating a substance of the second embodiment is a magnetic field generator using permanent magnets wherein a plurality of disc shaped permanent magnets 23 is provided in a cylindrical case 22 in such a manner that a magnetic direction changes at every one permanent magnet.

In the magnetic field generator 21 using permanent magnets, when a length of a cylindrical case of vibration magnetic field is defined as L [m], the number of permanent magnet is defined as N [−], a magnetic flux density is defined as B[T], and a flow velocity of water is defined as v[m/s], respectively, it can be defined that a vibration frequency F [1/s]=(N×v)/L. Furthermore, when cross-section is defined as A [m²], it can be defined that flow rate q of water [m³/s]=A×v.

When amount of treated water is defined as Q [m³/h], it can be defined that a time t [min] for applying a vibration magnetic field to water=(A×1)/(Q×60)=(q×N)/(F×Q×60).

Accordingly, it can be proven that water is treated for the time t [min] in the vibration magnetic filed having the magnetic flux density B [T] and the vibration frequency F [1/s] during the course that water is passed through the magnetic field generator 21.

According to the apparatus 20 for activating a substance of the second embodiment having the above mentioned structure and operation, water as the substance to be treated is passed through the cylindrical case wherein a plurality of disc shaped permanent magnets 23 are provided therein in such a manner that a magnetic direction can be changed at every one permanent magnet 23. By such a configuration, the vibration magnetic field can be imparted to water so that water can be easily activated.

Next, an apparatus for activating a substance of the third embodiment will now be described by referring to FIG. 3. FIG. 3 is a schematic drawing showing internal structure of the apparatus for activating a substance of the third embodiment. As shown in FIG. 3, the apparatus 30 for activating a substance of the third embodiment is comprised of an internal cylindrical case 33, an alternating-current power supply 35, and an external cylindrical case 34. Herein, the internal cylindrical case 33 has a coil 32, which is wound around the internal cylindrical case 33. The alternating-current power supply 35 supplies a power to the coil 32, which is wound around the internal cylindrical case 33. The external cylindrical case 34 includes the internal cylindrical case 33 therein.

In the magnetic field generator 31 using permanent magnets, when a frequency f of the alternating-current power supply is defined as [1/s], a length of a cylindrical case of vibration magnetic field is defined as L′ [m], a cross-section of the cylindrical case having a coil, which is wound around the cylindrical case is defined as A′ [m²], amount of treated water is defined as Q′ [m³/h], respectively, it can be defined that a vibration frequency F [1/s]=a frequency f of the alternating current power supply, while a time t′ [min] for applying a vibration magnetic field to water=(A′×L′)/(Q′×60). Furthermore, when an alternating current is defined as I [A], a winding number is defined as N′ [a number of winding], and a transmittance is defined as p [H/m], it can be defined that a magnetic flux density B′ [T]=(μ×I×N′)/L′.

Accordingly, it can be proven that water is treated for the time t′ [min] in the vibration magnetic filed having the magnetic flux density B′ [T] and the vibration frequency F′ {1/s} during the course that water is passed through the magnetic field generator 30.

According to the apparatus 30 for activating a substance of the third embodiment comprising the above mentioned structure and operation, water as the substance to be treated is passed through the cylindrical case of the magnetic field generator 31 using permanent magnets having the coil 32, which is wound around the magnetic field generator 31. Thus, water is activated by flowing the alternating current in the coil 32. By such a configuration, the vibration magnetic field can be imparted to water so that water can be easily activated.

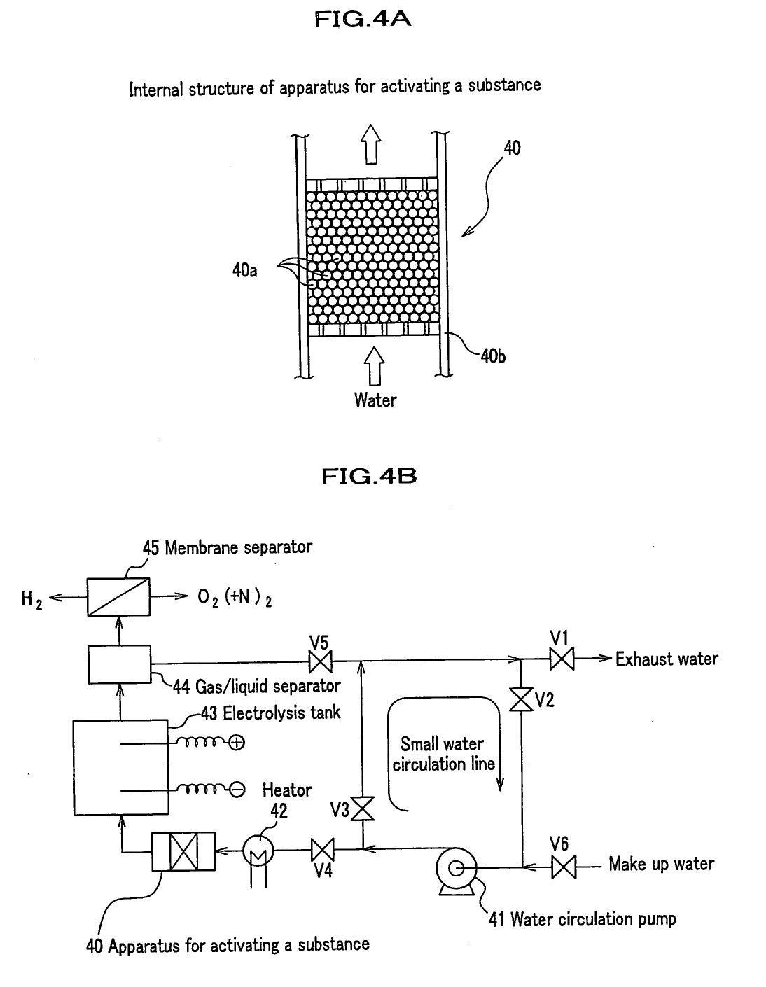

Next, an apparatus for activating a substance of the fourth embodiment will now be described by referring to FIG. 4, while the apparatus for activating a substance of the fourth embodiment is utilized in combination with at least any one of the apparatuses for activating a substance of the first, the second, and the third embodiment, and is provided on an upstream and/or a downstream thereof.

FIG. 4A is a drawing showing internal structure of the apparatus for activating a substance of the fourth embodiment. FIG. 4B is a process flow chart showing a process of generating hydrogen from water by utilizing the substance activating apparatus of the fourth embodiment.

As shown in FIG. 4A, the apparatus 40 for activating the substance according to the fourth embodiment includes the active structure in the container 40b. Herein, the active structure comprises one or more types of particles 40a consisting essentially of a single element selected from the group consisting of silicon, titanium, nickel and samarium placed in the position where a wave motion energy inherent to each of the elements is amplified to make up an energy focused place among the particles. In the fourth embodiment of the present invention, silicon as a single element is utilized as the particle 40a.

By such a configuration, a high energy (or an interaction thereof among the particles 40a is generated, i.e., an energy focused place is generated, and a substance can be activated by passing the substance through the energy focused place, or by staying the substance in the energy focused place.

Herein, “the position where a wave motion energy inherent to each of the elements is amplified” is the position that was experimentally determined. Specifically, it is the position where during the course that a substance is passed through or stayed in a space among the particles 40a composed of the specific element, an energy is imparted to the substance through the vibration and fluctuation inherent.

Furthermore, the particles 40a are a globe. The particles 40a are arranged at the apices of a regular tetrahedron wherein each particle 40a is piled up. The particles 40a can be also arranged at the apices of a regular triangle.

When the particles 40a are arranged at the apices of a regular tetrahedron as described above, a high energy (or an interaction thereof among the particles 40a is generated, i.e., an energy focused place is generated, and a substance can be activated by passing the substance through the energy focused place, or by staying the substance in the energy focused place.

The apparatus 40 for activating a substance of the fourth embodiment having the above mentioned structure will be now described by referring to FIG. 4B. Water as liquid is utilized as the substance to be treated. However, when either organic compounds except for water or gas such as oxygen may be utilized as the substance to be passed through the cylindrical case, such substance can also be activated.
(1) First, Valve V2, V3, V6 are opened whereby water is supplied from the valve V6 to the apparatus to form a small water circulation line. A water circulation pump 41 is started to circulation water. Valve V5 and V3 are in opened states, a valve V4 is in a closed state.
(2) Water is circulated within a large circulation line comprising a heater 42, the apparatus 40 for activating a substance to be treated, an electrolysis tank 43, a gas/liquid separator 44, the valve V5, the valve V2, the circulation pump 41, and the valve V4.
(3) The heater 12 is turned on. The reason why water is heated by the heater is for further accelerating the activation of water, as the subject.

When water is passed through the apparatus 40 for activating a substance according to the present invention, an energy is imparted to the water at the energy focused place to activate water.
(4) The electrolysis tank 13 is turned on. A gas is generated by electrolyzing water.

At this time, the water is heated by the heater 42, and the water molecules are further activated by the apparatus 40 for activating a substance, resulting in the fact that the electrolysis of the water within the electrolysis tank 43 is accelerated to increase the amount of hydrogen generated per unit power. (for example, 10 to 20% of the amount of hydrogen is increased.)
(5) The liquid containing bubbles exhausted from the electrolysis tank 43 is incorporated in the gas/liquid separator 44 at which the bubbles are selectively separated from the liquid containing the bubbles.
(6) The bubbles separated from the gas/liquid separator 44 are treated with a membrane separator 45 having a hydrogen permeable membrane. Then, the hydrogen is recovered (for example, recovery factor is 70%), while the gas containing oxygen, which cannot be transmitted through the hydrogen permeable membrane is discharged to the atmosphere as is.
(7) On the other hand, the liquid separated by the gas/liquid separator 44 is gain circulated within the system by means of the water circulation pump 41.
(8) The amount of the water having been electrolyzed and consumed during the course of the operation is supplemented from the valve 1 as supplementary water.

In the case where the activity of the apparatus 40 for activating a substance according to the present invention is high enough, the electrolysis tank 43 may be omitted. To the contrary, in the case where the activity is low, a plurality of the apparatus 40 for activating a substance may be provided in series and/or parallel so that the electrolysis tank 43 may be omitted.

According to the apparatus 40 for activating a substance of the fourth embodiment comprising the above mentioned structure and operation, the following effects can be brought about.
(1) Water as the substance to be treated is passed through the activating structure comprises particles 40a consisting essentially of a silicon as a single element placed in the position where a wave motion energy inherent to the silicon is amplified so that water as the substance is activated. By such a configuration, water can be suitably activated.
(2) When the apparatus 40 for activating the substance is utilized as an apparatus for preliminary treating water so as to be activated, water, which is preliminary activated, can be supplied to the system. By such a configuration, a decomposition reaction can be accelerated.

In the fourth embodiment, water as liquid is utilized as the substance to be treated. However, when either organic compound except for water or gas such as oxygen is utilized as the substance can also be activated.

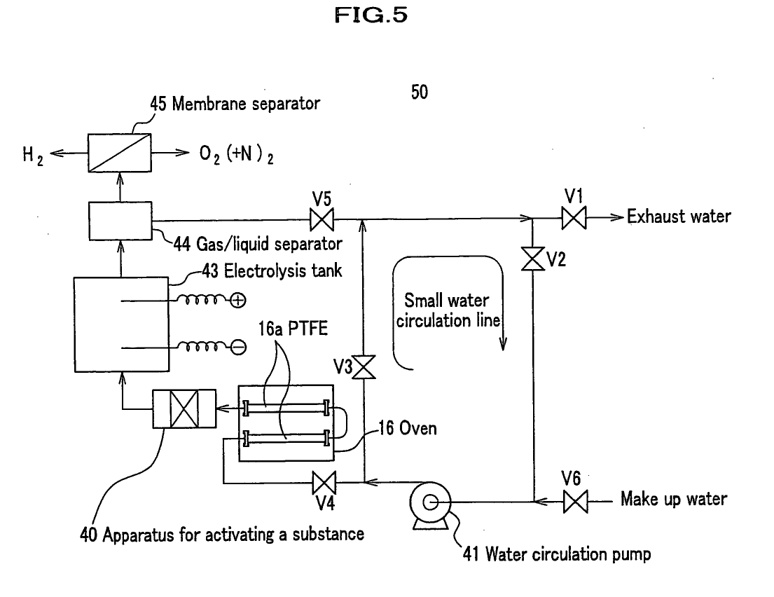

Next, an apparatus for activating a substance of the fifth embodiment will now be described by referring to FIG. 5. As shown in FIG. 5, the apparatus 50 for activating a substance of the fifth embodiment is utilized as an apparatus is composed of the apparatus 10 for activating a substance of the first embodiment and the apparatus 40 for activating a substance.

Specifically, the apparatus 50 for activating a substance of the fifth embodiment includes the apparatus utilizing the microwave oscillator 11 and the apparatus having the activating structure comprises particles consisting essentially of a silicon as a single element placed in the position where a wave motion energy inherent to the silicon is amplified.

With regard to the parts described in the explanations of the apparatus 10 for activating a substance of the first embodiment and the apparatus 40 for activating a substance of the fourth embodiment, they will be described by referring to the same number as these of the first embodiment and the fourth embodiment.

Operations of the apparatus 50 for activating a substance of the fifth embodiment having the above mentioned structure will be now described by reference to FIG. 5. FIG. 5 is a process flow chart showing a process for generating hydrogen from water by utilizing the apparatus 50 for activating a substance of the fifth embodiment regarding the present invention.

In the fifth embodiment, water as liquid is utilized as the substance to be treated. However, when either organic compound except for water or gas such as oxygen is utilized as the substance, the substance can also be activated.
(1) First, Valve V2, V3, V6 are opened whereby water is supplied from the valve V6 to the system to form a small water circulation line. A water circulation pump 41 is started to circulation water. Valve V5 and V3 are in opened states, a valve V4 is in a closed state.
(2) Water is circulated within a large circulation line comprising an oven 16, the apparatus 40 for activating a substance to be treated, an electrolysis tank 43, a gas/liquid separator 44, the valve V5, the valve V2, the circulation pump 41, and the valve V4.
(3) The oven 12 is turned on. The reason why water is heated by the microwave in the oven 16 is for further accelerating the activation of water, as the subject.

When water is passed through the oven 16 of the apparatus 50 for activating a substance of the fifth embodiment and the apparatus 40 for activating a substance provided at a downstream of the oven 16 of the apparatus 50 for activating a substance, an energy is imparted to the water, which was heated and activated in the oven 16, at the energy focused place to farther activate water.
(4) The electrolysis tank 13 is turned on. A gas is generated by electrolyzing water.

At this time, the water is heated and activated by the oven 16, and the water molecules are further activated by the apparatus 40 for activating a substance provided on an upstream of the apparatus 50, resulting in the fact that the electrolysis of the water within the electrolysis tank 43 is accelerated to increase the amount of hydrogen generated per unit power. (For example, 20 to 30% of the amount of hydrogen is increased.)
(5) The liquid containing bubbles exhausted from the electrolysis tank 43 is incorporated in the gas/liquid separator 44 at which the bubbles are selectively separated from the liquid containing the bubbles.
(6) The bubbles separated from the gas/liquid separator 44 are treated with a membrane separator 45 having a hydrogen permeable membrane. Then, the hydrogen is recovered (for example, recovery factor is 70%), while the gas containing oxygen, which cannot be transmitted through the hydrogen permeable membrane is discharged to the atmosphere as is.
(7) On the other hand, the liquid separated by the gas/liquid separator 44 is gain circulated within the system by means of the water circulation pump 41.
(8) The amount of the water having been electrolyzed and consumed during the course of the operation is supplemented from the valve 1 as supplementary water.

In the case where the activity of the apparatus 40 for activating a substance according to the present invention is high enough, the electrolysis tank 43 may be omitted. To the contrary, in the case where the activity is low, a plurality of the apparatus 40 for activating a substance may be provided in series and/or parallel so that the electrolysis tank 43 may be omitted.

According to the apparatus 50 for activating a substance of the fifth embodiment comprising the above mentioned structure and operation, the following effects can be brought about.
(1) The apparatus 50 for activating a substance includes the oven 16 utilizing the microwave oscillator 11 and the apparatus 40 having the active structure comprises particles consisting essentially of a silicon as a single element placed in the position where a wave motion energy inherent to the silicon is amplified. Water as the substance to be treated is circulated through the active structure. By such a configuration, water can be suitably activated. As a result, the electrolysis of the water within the electrolysis tank 43 is accelerated to increase the amount of hydrogen generated per unit power.
(2) The apparatus 50 for activating a substance includes the oven 16 utilizing the microwave oscillator 11 and the apparatus 40 having the activating structure comprises particles 40a consisting essentially of a silicon as a single element placed in the position where a wave motion energy inherent to the silicon is amplified. When the apparatus 40 for activating the substance is utilized as an apparatus for preliminary treating water so as to be activated, water, which is preliminary activated, can be supplied to the system.

In the fifth embodiment, while water as a substance to be treated is passed through the apparatus for activating a substance, the substance may also be activated when either organic compound or gas such as oxygen is passed through the apparatus for activating a substance. Furthermore, in the fifth embodiment, while particles consisting essentially of silicon as a single element is utilized, particles consisting essentially of a single element selected from the group consisting of titanium, nickel and samarium, or of a carbon fluoride may also utilized.

As described above, the apparatus for activating a substance regarding the first, second, third, fourth, fifth embodiment of the present invention were described. It is not necessary to say that at least any one of these apparatuses make it possible to activate water as a substance to be treated.

Finally, the apparatus for activating a substance is not restricted to the above mentioned apparatus of the first, second, third, fourth, and fifth embodiment, but it is practical to change a structure of the apparatus as long as it is not strayed from the scope of the present invention.

For example, the apparatus for activating a substance can be formed so that the apparatus 40 for activating a substance of the fourth embodiment is combined with at least any one of the apparatus 20, 30 for activating a substance.

Furthermore, the apparatus for activating a substance can be formed so that the electrolysis tank 43 is unified with the apparatus 40 for activating a substance. Specifically, the particles 40a in the apparatus 40 for activating a substance is formed into a plate so that the particles 40a can be utilized as an electrode of the electrolysis tank 43. Still furthermore, the apparatus for activating a substance can be formed so that the activating structure is stored into the pipe 16 in the oven 16. Thus, water can be activated in one apparatus.

### INDUSTRIAL APPLICABILITY

As described above, the present invention exhibits the following outstanding effects.

(1) A process of activating a substance comprises a process (A) that a substance to be treated is activated by treating with magnetism in which an energy power changes repeatedly. Thus, the substance can be activated by following up an external magnetism.

(2) The process of activating a substance comprises the above mentioned process (A), and a process (A) substance activated method (B) that the substance to be treated is activated before and/or after the process (A). Thus, the substance can be more suitably activated.

(3) The above mentioned process (A) is a method for applying a microwave generated in a high voltage-pulse oscillator to the substance. Thus, the substance can be activated by the microwave generated in a power source of a high voltage and a small amount of power consumption.

(4) The above mentioned process (A) is a method that the substance is passed through a cylindrical case wherein a plurality of permanent magnet is provided in such a manner that a magnetic direction is changed at every permanent magnet. Thus, the substance can be easily activated by imparting a vibration magnetic field to the substance.

(5) The above mentioned process (A) is a method that the substance is passed through a cylindrical case having a coil which is wound around the cylindrical case, while alternating current flows in the coil. Thus, the substance can be easily activated by imparting the vibration magnetic field to the substance.

(6) The above mentioned process (B) is an activating treatment process for passing the substance through the active structure comprising particles consisting essentially of a single element selected from the group consisting of silicon, titanium, nickel and samarium, or of a carbon fluoride placed in the position where a wave motion energy inherent to each of the elements or the carbon fluoride is amplified. Thus, the substance can be more preferably activated.

(7) The particles are arranged at the apices of a regular tetrahedron, or the apices of a regular triangle. Thus, a high energy (or an interaction thereof among the particles is generated, i.e., an energy focused place is generated, and a substance can be activated by passing the substance through the energy focused place, or by staying the substance in the energy focused place.

(8) The substance is activated with a magnetism in which an energy power changes repeatedly. Thus, polarized molecules in the substance can be activated by following up an external magnetism.

(9) The above mentioned apparatus for activating a substance is provided on an upstream and/or a downstream of the former apparatus for activating a substance. Thus, the substance can be suitably activated.

(10) The above mentioned apparatus for activating the substance is an apparatus in which magnetism generated by means of a high voltage pulse oscillator is applied to the substance. Thus, the substance can be activated by a microwave generated by means of a power supply which is a high voltage and a small amount of electric power consumption.

(11) The above mentioned apparatus for activating the substance is an apparatus in which a plurality of permanent magnet is provided in a cylindrical case in such a manner that a magnetic direction is changed at every one permanent magnet. The magnetism can be imparted to the substance by only passing the substance through the cylindrical case. Thus, the substance can be activated.

(12) The above mentioned apparatus for activating the substance is a magnetic field generator using permanent magnets wherein an internal cylindrical case having a coil, which is wound around the internal cylindrical case to flow current therein, is provided in an external cylindrical case. The magnetism can be imparted to the substance by only passing the substance through the cylindrical case. Thus, the substance can be suitably activated.

(13) The above mentioned apparatus for activating the substance is an apparatus including an activating structure comprising particles consisting essentially of a single element selected from the group consisting of silicon, titanium, nickel and samarium, or of a carbon fluoride placed in the position where a wave motion energy inherent to each of the elements or the carbon fluoride is amplified. Thus, the substance can be more suitably activated.

(14) The particles are arranged at the apices of a regular tetrahedron, or the apices of a regular triangle. Thus, a high energy (or an interaction thereof among the particles is generated, i.e., an energy focused place is generated, and a substance can be activated by passing the substance through the energy focused place, or by staying the substance in the energy focused place.

1. A process for activating a substance comprising;
(A) a process for activating a substance to be treated by treating with magnetism in which an energy power changes repeatedly.

2. The process for activating a substance according to claim 1, further comprising;
(B) a process for activating the substance to be treated before and/or after the process (A).

3. The process for activating a substance according to claim 1, wherein
said process (A) is a method for applying a microwave, which is generated in a high voltage-pulse oscillator, to the substance.

4. The process for activating a substance according to claim 1, wherein the
substance is passed through a cylindrical case wherein a plurality of permanent magnet is provided in such a manner that a magnetic direction is changed at every permanent magnet.

5. The process for activating a substance according to claim 1, wherein the
substance is passed through a cylindrical case having a coil, which is wound around the cylindrical case, while alternating current flows in the coil.

6. The process for activating a substance according to claim 2, wherein
said process (B) is an activating treatment process for passing the substance through the activating structure comprising particles consisting essentially of a single element selected from the group consisting of silicon, titanium, nickel, and samarium, or of a carbon fluoride placed in the position where a wave motion energy inherent to each of the elements or the carbon fluoride is amplified.

7. The process for activating a substance according to claims 6, wherein said particles are arranged at the apices of a regular tetrahedron, or the apices of a regular triangle.

8. An apparatus for activating a substance comprising;
an apparatus in which the substance is activated with a magnetism in which an energy power changes repeatedly.

9. The apparatus for activating a substance comprising;
the apparatus for activating a substance according to claim 8, and
an apparatus for activating a substance provided on an upstream and/or a downstream of the former apparatus for activating a substance.

10. The apparatus for activating a substance according to claims 8,
wherein said apparatus, in which magnetism is imparted to said substance, is an apparatus in which magnetism generated by means of a high voltage pulse oscillator is applied to the substance.

11. The apparatus for activating a substance according to claims 8,
wherein said apparatus, in which magnetism is imparted to said substance, is an apparatus in which a plurality of permanent magnet is provided in a cylindrical case in such a manner that a magnetic direction is changed at every one permanent magnet.

12. The apparatus for activating a substance according to claims 8,
wherein said apparatus, in which magnetism is imparted to said substance, is a magnetic field generator using permanent magnets wherein an internal cylindrical case having a coil, which is wound around the internal cylindrical case to flow current therein, is provided in an external cylindrical case.

13. The substance activating apparatus according to claim 9, wherein the apparatus for activating the substance at an upper portion and/or a lower portion of the substance activating apparatus, in which the substance is activated with a magnetism in which an energy power changes repeatedly, includes an activating structure comprising particles consisting essentially of a single element selected from the group consisting of silicon, titanium, nickel, and samarium, or of a carbon fluoride placed in the position where a wave motion energy inherent to each of the elements or the carbon fluoride is amplified.

14. The substance activating apparatus according to claim 13, wherein the particles are arranged at the apices of a regular tetrahedron, or the apices of a regular triangle.
